(19) United States
(12) Patent Application Publication
(10) Pub. No.: US 2025/0392557 A1
(43) Pub. Date: Dec. 25, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Koji TSUKAMOTO, Tokyo (JP); Hiromu YAMAWAKI, Tokyo (JP); Toshinori MIYOSHI, Tokyo (JP)

(21) Appl. No.: 19/072,572

(22) Filed: Mar. 6, 2025

(30) Foreign Application Priority Data
Jun. 20, 2024 (JP) 2024-099781

(51) Int. Cl. H04L 51/02; H04L 51/216

(52) U.S. Cl. CPC H04L 51/02; H04L 51/216

(57) ABSTRACT

An information processing apparatus according to the present application includes a personal agent identification unit, an inquiry unit, and a providing unit. The personal agent identification unit identifies a plurality of personal agents each being associated with a corresponding user among a plurality of users who are grouped. The inquiry unit makes an inquiry to one or more personal agents among the plurality of personal agents that are identified by the personal agent identification unit about predetermined information that is used to provide a service to a group corresponding to the plurality of users. The providing unit provides the service to the group by using information that is provided by the one or more personal agents in accordance with an inquiry that is made by the inquiry unit.

### CROSS-REFERENCE TO RELATED APPLICATIONS

The present application claims priority to and incorporates by reference the entire contents of Japanese Patent Application No. 2024-099781 filed in Japan on Jun. 20, 2024.

### BACKGROUND OF THE INVENTION

### 1. Field of the Invention

The present invention relates to an information processing apparatus, an information processing method, and an information processing program.

### 2. Description of the Related Art

Conventionally, a technology for providing an advertisement via a network is known. For example, Japanese Laid-open Patent Publication No. 2024-027355 proposes a technology for forming a chat group that includes a user and at least one of a staff member in a customer service store and a cast who belongs to the customer service store, and providing a reservation guidance service in a chat room of the chat group.

However, in the conventional technology as described above, an advertisement is not provided unless the cast or the staff member selects a “reservation guidance for customer service store” button, and there is a problem with convenience in service provision.

### SUMMARY OF THE INVENTION

An information processing apparatus according to the present application includes a personal agent identification unit, an inquiry unit, and a providing unit. The personal agent identification unit identifies a plurality of personal agents each being associated with a corresponding user among a plurality of users who are grouped. The inquiry unit makes an inquiry to one or more personal agents among the plurality of personal agents that are identified by the personal agent identification unit about predetermined information that is used to provide a service to a group corresponding to the plurality of users. The providing unit provides the service to the group by using information that is provided by the one or more personal agents in accordance with an inquiry that is made by the inquiry unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to one embodiment;

FIG. 2 is a diagram illustrating an example of a configuration of an information processing system according to one embodiment;

FIG. 3 is a diagram illustrating an example of a configuration of an information processing apparatus according to one embodiment;

FIG. 4 is a diagram illustrating an example of a user information table that is stored in a user information storage unit of the information processing apparatus according to one embodiment;

FIG. 5 is a diagram illustrating an example of a chat setting information table that is stored in a chat setting information storage unit of the information processing apparatus according to one embodiment;

FIG. 6 is a diagram illustrating an example of a conversation history table that is stored in a conversation history storage unit of the information processing apparatus according to one embodiment;

FIG. 7 is a diagram illustrating an example of a configuration of a group agent processing unit in a processing unit of the information processing apparatus according to one embodiment;

FIG. 8 is a diagram illustrating an example of a configuration of an identification unit in a group agent processing unit of the information processing apparatus according to one embodiment;

FIG. 9 is a diagram illustrating an example of a configuration of an inquiry unit in the group agent processing unit of the information processing apparatus according to one embodiment;

FIG. 10 is a diagram illustrating an example of a configuration of a providing unit in the group agent processing unit of the information processing apparatus according to one embodiment;

FIG. 11 is a diagram illustrating an example of service information that is provided to a terminal apparatus by the providing unit in the processing unit in the processing unit of the information processing apparatus according to one embodiment and that is displayed on the terminal apparatus;

FIG. 12 is a flowchart illustrating an example of information processing that is performed by the processing unit of the information processing apparatus according to one embodiment; and

FIG. 13 is a diagram illustrating an example of a hardware configuration of a computer that implements functions of the information processing apparatus according to one embodiment.

### DETAILED DESCRIPTION OF THE PREFERRED EMBODIMENTS

Modes (hereinafter, described as “embodiments”) for carrying out an information processing apparatus, an information processing method, and an information processing program according to the present application will be described in detail below with reference to the drawings. Meanwhile, the information processing apparatus, the information processing method, and the information processing program according to the present application are not limited by the embodiments below. Further, embodiments may be combined appropriately as long as processing contents do not conflict with each other. Furthermore, in each of the embodiments described below, the same components are denoted by the same reference symbols, and repeated explanation will be omitted.

### 1. One Example of Information Processing

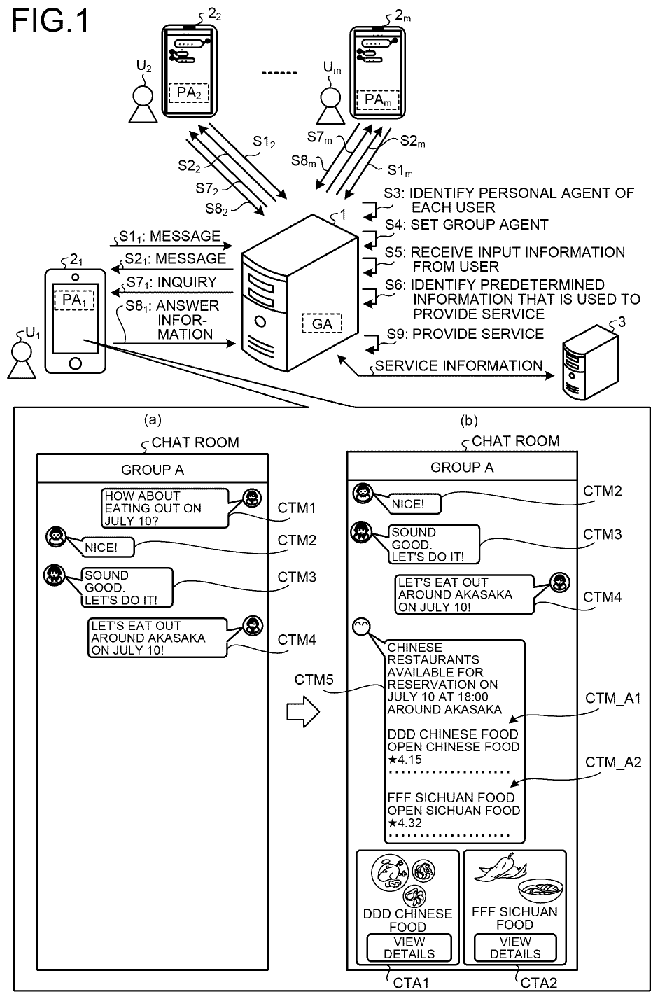

FIG. 1 is a diagram illustrating an example of information processing according to one embodiment, and, in the present embodiment, an information processing apparatus implements an information processing method.

As illustrated in FIG. 1, an information processing apparatus 1 is communicably connected to terminal apparatuses 2₁, 2₂, . . . 2ₘ and a service providing apparatus 3, and transmits and receives information to and from the terminal apparatuses 2₁, 2₂, . . . , 2ₘ and the service providing apparatus 3. m is, for example, an integer equal to or larger than three.

The information processing apparatus 1 provides a chat service for transmitting and receiving a chat message among the terminal apparatuses 2₁, 2₂, . . . , 2ₘ to users U₁, U₂, . . . , Uₘ of the terminal apparatuses 2₁, 2₂, . . . , 2ₘ.

In the following, when each of the terminal apparatuses 2₁, 2₂, . . . , 2ₘ is described without being individually distinguished, each of the terminal apparatuses 2₁, 2₂, . . . , 2ₘ may be described as a terminal apparatus 2, and, when each of the users U₁, U₂, . . . , Uₘ is described without being individually distinguished, each of the users U₁, U₂, . . . , Uₘ may be described as a user U. The terminal apparatus 2 may be, for example, a smartphone, a tablet Personal Computer (PC), a notebook PC, or the like.

The service providing apparatus 3 provides various kinds of online services. For example, the service providing apparatus 3 provides various kinds of search services, various kinds of reservation services, an advertisement distribution service, a map information providing service, an electronic commerce service, or the like.

The service providing apparatus 3 provides, for example, an Application Programming Interface (API), and the information processing apparatus 1 and the terminal apparatus 2 are able to transmit and receive various kinds of information on various kinds of online services via the API that is provided by the service providing apparatus 3.

The terminal apparatus 2₁ is used by the user U₁, the terminal apparatus 2₂ is used by the user U₂, and the terminal apparatus 2ₘ is used by the user Uₘ. The users U₁, U₂, . . . , Uₘ are participants to the same chat group, and an application of an instant messenger for performing a group chat that is a chat performed by a chat group is installed in each of the terminal apparatuses 2₁, 2₂, . . . 2ₘ. In the following, the application of the instant messenger may be described as a chat application.

The instant messenger is able to transmit and receive a message in the group chat, transmit and receive a message in a one-to-one chat, transmit and receive a message in a one-to-many chat, or the like. Examples of the message that is transmitted and received by the chat application includes a character, a stamp, and a captured image.

Each of the users U₁, U₂, . . . , Uₘ operates a corresponding terminal apparatus among the terminal apparatuses 2₁, 2₂, . . . , 2ₘ, and exchanges a message in the chat group. Specifically, each of the users U₁, U₂, . . . , Uₘ operates a corresponding terminal apparatus among the terminal apparatuses 2₁, 2₂, . . . , 2ₘ, and transmits a message of the group chat to the information processing apparatus 1 via a network (not illustrated) (Steps S1₁, S1₂, . . . . S1ₘ).

The information processing apparatus 1 receives a message of the group chat, which is transmitted from the terminal apparatuses 2₁, 2₂, . . . , 2ₘ, and transmits the received message of the group chat to the terminal apparatuses 2 of the users U other than the user U who has transmitted the message via the network (not illustrated) (Step S2₁, S2₂, . . . S2ₘ). The terminal apparatuses 2₁, 2₂, . . . , 2ₘ receive a chat message that is a message of the group chat and that is transmitted from the information processing apparatus 1, and displays the received chat message in a chat room of the group chat.

In an example illustrated in (a) in FIG. 1, the terminal apparatus 2₁ displays chat messages CTM1 and CTM4 of the user Uy, a chat message CTM2 of the user U₂, and a chat message CTM3 of the user Uₘ. Further, a name of the chat group is a group A.

The chat message CTM1 is information on a character string of “How about eating out on July 10?”, and the chat message CTM2 is information on a character string of “Nice!”. Further, the chat message CTM3 is information on a character string of “Sounds good. Let's do it!”, the chat message CTM4 is information on a character string of “Let's eat out around Akasaka on July 10!”.

Furthermore, the information processing apparatus 1 identifies a plurality of personal agents PA₁, PA₂, . . . , PAₘ each of which is associated with a corresponding user among the plurality of users U₁, U₂, . . . , Uₘ who are grouped as the group A that is a chat group (Step S3).

The information processing apparatus 1 identifies a personal agent of a chat application in which a user IDentifier (ID) of the user U is set, as a personal agent of the user U. The user ID is an account of the user U that is set in the chat application.

For example, the information processing apparatus 1 identifies, as the personal agent PA₁, a personal agent of the chat application in which the user ID of the user U₁ is set and which operates on the terminal apparatus 2₁. Further, the information processing apparatus 1 identifies, as the personal agent PAZ, a personal agent of the chat application in which the user ID of the user U₂ is set and which operates on the terminal apparatus 2₂.

Furthermore, the information processing apparatus 1 identifies, as the personal agent PAₘ, a personal agent of the chat application in which the user ID of the user Uₘ is set and which operates on the terminal apparatus 2ₘ. In the following, when each of the personal agents PA₁, PA₂₁ . . . , PAₘ is described without being individually distinguished, each of the personal agents PA₁, PA₂, . . . , PAₘ may be described as a personal agent PA. The personal agent PA is a service agent for each of the users U, and may be, for example, Auto-GPT or the like.

The personal agent PA is one of functions that are included in the chat application, and functions as an agent for the user U. For example, the personal agent PA₁ functions as an agent for the user U₁, the personal agent PA₂ functions as an agent for the user U₂, and the personal agent PA, functions as an agent for the user Uₘ:

The information processing apparatus 1 performs the process in Step S3 before the processes in Step S1₁, S1₂, . . . . S1ₘ, but embodiments are not limited to this example, and may perform the process in Step S3 before a process in Step S4. For example, the information processing apparatus 1 performs the process in Step S3 when the users U₁, U₂, . . . , Uₘ are grouped.

A timing at which the users U₁, U₂, . . . , Uₘ are grouped may be a timing at which the group A is set, a timing at which a chat room of the group A is created, or the like, but embodiments are not limited to this example. For example, the timing at which the users U₁, U₂, . . . , Uₘ are grouped may be a timing at which a chat message is posted in the chat room of the group A, or the like.

Furthermore, when the users U₁, U₂, . . . , Uₘ are grouped, the information processing apparatus 1 sets a group agent GA of the group A of the user U₁, U₂, . . . , Uₘ who are grouped (Step S4). The group agent GA is, for example, a service agent for each of groups, and may be, for example, Auto-GPT or the like. The group agent GA is set in units of groups; however, it may be possible to set a group agent across a plurality of groups or set a single group agent for all of groups.

The group agent GA transmits and receive information between the plurality of personal agents PA corresponding to the plurality of users U who are grouped, so that the information is shared among the plurality of personal agents PA and more optimal information is provided to the group.

The group agent GA of the information processing apparatus 1 receives, as input information, a chat message that is input by the user U (Step S5). For example, in the example illustrated in (a) in FIG. 1, the group agent GA receives, as the input information, the chat messages CTM1, CTM2, CTM3, and CTM4 that are input by the users U₁, U₂, and Uₘ.

The chat messages CTM1 and CTM4 of the user U are messages about eating out, and information on a restaurant search service that is provided by the service providing apparatus 3. The group agent GA receives, in Step S5, the chat messages CTM1 and CTM4 as the message including the information on the service from the user U₁.

The information on the service is information on a service that is provided by the service providing apparatus 3, but may be information on a service that is provided a different service providing apparatus other than the service providing apparatus 3.

Subsequently, the group agent GA identifies predetermined information that is used to provide a service to the group A corresponding to the plurality of users U₁, U₂, . . . , Uₘ, based on the input information that is received in Step S5 (Step S6).

The group agent GA performs the process in Step S6 regardless of whether or not the input information that is received in Step S5 includes the information on the service, but embodiments are not limited to this example. For example, the group agent GA may perform the process in Step S6 only when the input information that is received in Step S5 includes a specific term or a specific phrase, or may perform the process in Step S6 only when the input information that is received in Step S5 does not include a specific term or a specific phrase. In the following, Step S6 will be separated into Step S6-1 and Step S6-2, which will be described below.

The group agent GA identifies, in Step S6, a type of the service and values of one or more parameters among a plurality of parameters that are used to provide the service of the type, based on the input information that is received in Step S5 (Step S6-1).

The type of the service is, for example, the restaurant search service, a hotel search service, a restaurant reservation service, a hotel reservation service, the advertisement distribution service, the map information providing service, the electronic commerce service, or the like, but embodiments are not limited to this example. In the following, the type of the service may be described as a service type.

The plurality of parameters that are used to provide the service include a mandatory parameter that is a parameter needed to provide the service and an additional parameter that is a parameter for increasing accuracy of service provision.

When the service type is the restaurant search service, the mandatory parameter is, for example, an area of a restaurant, scheduled date and time of eating out, the number of people, or the like, and the additional parameter is a genre of food, a price range, a seat (terrace, table, tatami room), facilities (wheelchair, pets allowed), evaluation, allergic ingredients, display order, maximum number of acquisitions, or the like, but embodiments are not limited to this example.

Furthermore, when the service type is the hotel search service, the mandatory parameter is, for example, an area of a hotel, scheduled date and time of stay, the number of people, or the like, and the additional parameter is the number of rooms, the number of adults, the number of children, evaluation, a price range, facilities/services (wifi, Japanese-style room/Western-style room, double bed, single bed, no smoking/smoking), display order, maximum number of acquisitions or the like, but embodiments are not limited to this example.

Moreover, when the service type is the restaurant reservation service, the mandatory parameter is, for example, an area of a restaurant, scheduled date and time of eating out, the number of people, or the like, and the additional parameter is a genre of food, a seat (terrace, table, tatami room), allergic ingredients or the like, but embodiments are not limited to this example.

Furthermore, when the service type is the hotel reservation service, the mandatory parameter is, for example, an area of a hotel, scheduled date and time of stay, the number of people, or the like, and the additional parameter is the number of rooms, the number of adults, the number of children, a price range, a room type, facilities/services (wifi, Japanese-style room/Western-style room, double bed, single bed, no smoking/smoking), or the like, but embodiments are not limited to this example.

In Step S6-1, the group agent GA is able to, for example, identify values of the plurality of parameters that are used to provide the service, and identifies a value of a parameter for which the value is identifiable from the input information that is received in Step S5 among the plurality of parameters.

For example, when it is possible to identify values of one or more mandatory parameters based on the input information that is received in Step S5, the group agent GA identifies the values of one or more mandatory parameters. Furthermore, when it is possible to identify values of one or more additional parameters based on the input information that is received in Step S5, the group agent GA identifies the values of one or more additional parameters.

The group agent GA identifies, for example, a service type and values of one or more parameters among a plurality of parameters that are used to provide the service of the service type, by using generative Artificial Intelligence (AI) based on the information on the service received in Step S6.

The generative AI is, for example, text generative AI. The text the generative AI is, for example, Large Language Models that are trained to estimate and output a next token from an input token string, and is, for example, a transformer-based model, a Recurrent Neural Network (RNN)-based model, or the like.

Examples of the transformer-based model include a Generative Pre-trained Transformer (GPT), but embodiments are not limited to this example. Examples of the RNN-based model include a Receptance Weighted Key Value (RWKV), but embodiments are not limited to this example.

Meanwhile, the generative AI may be a language model that is trained (for example, fine-tuning) exclusively for generating answer information. The generative AI is arranged in an external information processing apparatus, and the group agent GA uses the generative AI via an API; however, the generative AI may be arranged in the information processing apparatus 1.

The group agent GA is able to input, to the generative AI, information that includes the chat message that is received as the input information in Step S5 and instruction information, and cause the generative AI to output the service type and values of one or more parameters. The instruction information is information for instructing the generative AI to identify a service type and values of one or more parameters that are used to provide a service of the service type from the chat message that is received as the input information in Step S5.

The instruction information includes, for example, information on a character string of “Please identify a type of a service and a value of a parameter that is used to provide the service of this type from the given message. Please identify the type of the service from a service type list below, and identify the value of the parameter from a parameter list below. Please output an identification result in an output format below.” and information on the service type list, the parameter list, and the output format.

The service type list includes, for example, information in which a service type and information indicating a content of a service are associated with each other for each of service types. The parameter list includes, for each of the service types, information in which a parameter and information indicating a content of the parameter are associated with each other for each of parameters, for example. Meanwhile, the instruction information is not limited to the example as described above, and may be any information as long as it is possible to output a type of a service and a value of a parameter that is used to provide the service of this type from a message.

Furthermore, when the generative AI is a GPT that is provide by OpenAI, it is possible to cause the generative AI to output the service type and values of one or more parameters by using a function calling function. In this case, information that is input to the generative AI includes, for each of the service types, information that indicates a definition of a service type, information that indicates a definition of each parameter, or the like.

Moreover, when the generative AI is fine-tuned so as to output a type of the service and a value of a parameter that is used to provide the service of this type from a message, the input information that is input to the generative AI need not always include the instruction information.

Furthermore, the group agent GA may be configured to identify the type of the service and the value of the parameter that is used to provide the service of this type from the message by a well-known slot filling technology without using the generative AI.

The group agent GA identifies, as predetermined information, information on an unidentified parameter that is a parameter for which a value is not yet identified among the plurality of parameters that correspond to the service of the type that is identified in Step S6-1 (Step S6-2).

The group agent GA identifies a plurality of parameters that are associated with the service type that is identified in Step S6-1. The group agent GA stores therein, for each of the services, the service type and the plurality of parameters in an associated manner. The plurality of parameters include the mandatory parameter and the additional parameter as described above.

The group agent GA identifies a plurality of parameters that are associated with the service type that is identified in Step S6-1 from among the stored service types of the respective services and the plurality of parameters for each of the service types.

For example, the group agent GA identifies, as the unidentified parameter, a mandatory parameter for which a value is not yet identified from among the plurality of parameters that are associated with the service type that is identified in Step S6-1. Furthermore, the group agent GA may identify, as the unidentified parameter, an unidentified additional parameter, in addition to the mandatory parameter for which the value is not yet identified from among the plurality of parameters.

Moreover, when the instruction information is set such that the generative AI outputs information on a parameter for which a value is not yet identified, the group agent GA may identify an unidentified parameter from among the plurality of parameters that are associated with the service type that is identified in Step S6-1 based on the information that is output from the generative AI.

Subsequently, the group agent GA makes an inquiry to one or more personal agents among the plurality of personal agents PA₁, PA₂, . . . PAₘ that are identified in Step S3 about predetermined information that is used to provide a service to a group that corresponds to the plurality of users U₁, U₂, . . . , Uₘ (Step S7₁, S7₂, . . . , S7ₘ). In the following, the personal agent PA to which the inquiry about the predetermined information is made may be described as a target personal agent.

In Step S7, the group agent GA identifies, for example, one or more target personal agents TPA based on the predetermined information that is identified in Step S6. For example, when the predetermined information that is identified in Step S6 is information on all of the users U in the group A, the group agent GA identifies, as the target personal agents TPA, the personal agents PA₁, PA₂, . . . , PAₘ of all of the users U₁, U₂, . . . , Uₘ in the group A.

Furthermore, when the predetermined information that is identified in Step S6 is information on a certain user U in the group A, the group agent GA identifies, as the target personal agent TPA, the personal agent PA of the certain user U.

In Step S7, the group agent GA outputs, to the target personal agent TPA, inquiry information for inquiring the information on the unidentified parameter that is identified as the predetermined information in Step S6-2.

The information on the unidentified parameter is, for example, information for acquiring a value of the unidentified parameter, and the inquiry information is information for directly inquiring the value of the unidentified parameter or information for inquiring information that is used to determine the value of the unidentified parameter.

The group agent GA has, for each of the service types, information that is associated with inquiry information for each of the parameters, identifies inquiry information corresponding to the unidentified parameter that is identified in Step S6-2, and outputs the identified inquiry information to the target personal agent TPA.

When the service type that is identified in Step S6-1 is the restaurant search service, and the unidentified parameter that is identified in Step S6-2 is the genre of food, the inquiry information is, for example, information on a character string of “Restaurants that are available for reservation are to be searched for. What genre of restaurant do you like?”, but embodiments are not limited to this example.

Furthermore, in Step S7, the group agent GA may generate the inquiry information for inquiring, as the predetermined information, the value of the unidentified parameter by using the generative AI. The group agent GA inputs, to the generative AI, information including, for example, instruction information for instructing generation of a sentence for inquiring the value of the unidentified parameter that is identified in Step S6-2, and causes the generative AI to generate the inquiry information.

When the service type that is identified in Step S6-1 is the restaurant search service, and the unidentified parameter that is identified in Step S6-2 is the genre of food, the instruction information that is to be input to the generative AI includes, for example, information on a character string of “Generate a sentence for inquiring a genre of food for searching for restaurants that are available for reservation.”.

The group agent GA has, for each of the service types, instruction information in which instruction information is associated with each of the parameters, identifies instruction information corresponding to the unidentified parameter that is identified in Step S6-2, inputs information including the identified instruction information to the generative AI, and causes the generative AI to generate the inquiry information.

Furthermore, when the information that is used to determine the value of the unidentified parameter is the information for generating a persona of the group A, the group agent GA generates or determines, as the inquiry information, information for inquiring the attribute information on the user U.

The target personal agent TPA generates answer information that indicates an answer to the inquiry information in response to an inquiry from the group agent GA, and outputs the generated answer information to the group agent GA (Steps S8₁, S8₂, . . . , and S8ₘ).

The target personal agent TPA has the information on the user U, and is able to generate the answer information based on the information on the user U. The information on the user U includes information on an attribute of the user U, information on a schedule of the user U, information on a behavior pattern of the user U, or the like. For example, the target personal agent TPA generates the answer information that includes a certain type of the information on the user U in accordance with the inquiry information.

The attribute of the user U is, for example, a demographic attribute, a psychographic attribute, or the like. The demographic attribute is a demographic attribute of the user U. The psychographic attribute is, for example, an attribute that indicates an interest, values, a lifestyle, a character, or the like of the user U. The behavior pattern of the user U is, for example, a behavior pattern of each of the users U in an online environment, but may include a behavior pattern of each of the users U in an offline environment.

The target personal agent TPA inputs, as the input information, information that includes the inquiry information and the instruction information to the generative AI, and causes the generative AI to identify a type of the information on the user U that is needed by the inquiry information. The instruction information includes a sentence for instructing identification of the type of the information on the user U that is needed by the inquiry information. The type of the information on the user U is, for example, an age, gender, a place of residence, an occupation, a type of an interest, a type of a behavior pattern, or the like of the user U, but embodiments are not limited to this example.

Furthermore, the target personal agent TPA may have an information identification list that includes the type of the information on the user U and one or more characteristic words, and may identify, as the information on the user U that is needed by the inquiry information, a certain type of information corresponding to the characteristic word that is included in the inquiry information from among characteristic words in the information identification list.

The target personal agent TPA has, for each type of the service, answer possibility information that indicates whether or not an answer is possible for each type of the information on the user U for example, and the answer possibility information is set by, for example, the user U of the terminal apparatus 2 that includes the target personal agent TPA.

The target personal agent TPA generates the answer information that includes information on an unidentified parameter when the answer possibility information includes setting indicating that an answer is possible with respect to the identified type of the information on the user U, and generates the answer information indicating that the answer is impossible in other cases. The target personal agent TPA generates the answer information that includes the identified type of the information on the user U, and outputs the generated answer information to the group agent GA.

Furthermore, the target personal agent TPA may include, for each type of the service, inquiry necessity information that indicates necessity of an inquiry to the user U for each type of the information on the user U, for example. The inquiry necessity information is set by, for example, the user U of the terminal apparatus 2 that includes the target personal agent TPA.

In this case, when the inquiry necessity information includes setting indicating that an inquiry about the identified type of the information on the user U needs to be made to the user U, the target personal agent TPA displays, in a pop-up manner, an inquiry message for inquiring if it is allowed to output the answer information including the identified type of the information on the user U, in a display area of the terminal apparatus 2.

When the user U inputs positive information (for example, information on a character string of “Yes”, information on a character string of “OK”, or the like) in response to the inquiry message that is displayed in a pop-up manner, the target personal agent TPA outputs the generated answer information to the group agent GA.

The group agent GA provides a service to the group A by using the answer information that is provided by the one or more target personal agents TPA in Step S8₁, S8₂, . . . , S8ₘ in response to the inquires that is made in Step S7₁, S7₂, . . . , S7ₘ (Step S9). In the following, the process in Step S9 is separated into Step S9-1, Step S9-2, and Step S9-3, which will be described below.

In Step S9, the group agent GA acquires the answer information that is output from each of the target personal agents TPA, and determines a value of an unset parameter based on the acquired answer information (Step S9-1).

For example, when the unidentified parameter is the genre of food, in the answer information that is output from each of the target personal agents TPA, the group agent GA determines the value of the unidentified parameter based on a genre of food that is preferred by each of the users U. For example, the group agent GA determines, as the value of the unidentified parameter, a genre of food that is commonly preferred by a predetermined percentage or more (for example, 50% or more) of the plurality of users U who belong to the group A.

Furthermore, the group agent GA may estimate the persona of the group A based on the answer information that is output from the target personal agent TPA. For example, when the answer information is the attribute information on each of the users U₁, U₂, . . . , Uₘ of the group A, the group agent GA determines, as the persona of the group A, various kinds of interests or lack of interests of the group A, the number of people in the group A, an age group of the group A (for example, an age group or an average age group from the youngest to the oldest, or the like), gender of the group, or the like.

The group agent GA is able to determine the value of the unidentified parameter based on the persona of the group A. For example, it is assumed that the identified service type is the restaurant search service, the group A is a group of four men who are in their 40s and who love grilled meat, and unidentified parameters are the number of people and the genre of food. In this case, the group agent GA determines that the parameter of the number of people is set to four and the parameter of the genre of food is set to grilled meat.

The group agent GA acquires service information that is information on the service from the service providing apparatus 3 based on the type of the service that is identified in Step S6-1 and values of the plurality of parameters that correspond to the service of this type and that include the value of the unidentified parameter that is determined in Step S9-1 (Step S9-2).

For example, when the service type that is identified in Step S6-1 is the restaurant search service, the group agent GA designates the restaurant search service, and transmits a search request that includes values of an area of a restaurant, a genre of food, scheduled date and time of eating out, and the number of people to the service providing apparatus 3 via the API of the service providing apparatus 3.

The service providing apparatus 3 searches for a plurality of restaurants in accordance with the search request, and acquires a search result as the information on the service of the service type that is identified in Step S6-1. The search result includes, for example, information on a name, a place, a category, information such as an introduction text, or the like of each of the retrieved restaurants, but embodiments are not limited to this example.

Furthermore, when the service type that is identified in Step S6-1 is the hotel reservation service, the group agent GA designates the hotel reservation service, and transmits a reservation request that includes values of an area of a hotel, scheduled date and time of stay, and the number of people to the service providing apparatus 3 via the API of the service providing apparatus 3.

The service providing apparatus 3 performs a reservation process in accordance with the reservation request, and acquires a result of the reservation process as the information on the service of the service type that is identified in Step S6-1. The result of the reservation process includes, for example, information on a character string of “Reservation is completed”, information on reservation details, and the like, but embodiments are not limited to this example.

The group agent GA provides the service information that is acquired in Step S9-2 to the group A, and provides the service to the group A (Step S9-3). In Step S9-3, the group agent GA transmits the service information that is acquired in Step S9-2 to the terminal apparatuses 2₁, 2₂, . . . , 2ₘ of the user U₁, U₂, . . . , Uₘ who belong to the group A, and provides the service information that is acquired in Step S9-2 to the group A.

When receiving the service information from the group agent GA, the terminal apparatuses 2₁, 2₂, . . . , 2ₘ display the received service information as a chat message in the chat room in which the chat message that is received in Step S5 is displayed.

Furthermore, the terminal apparatuses 2₁, 2₂, . . . , 2ₘ may display the received service information in the chat room in a different format from the chat message, or display the received service information in a pop-up window that is superimposed on the chat room.

In the example illustrated in (b) in FIG. 1, in the chat room of the group A in the terminal apparatus 2₁, restaurant information CTA1, restaurant information CTA2, restaurant information CTM_A1, and restaurant information CTM_A2 are displayed. The restaurant information CTA1 and the restaurant information CTM_A1 are pieces of information on DDD Chinese food, and the restaurant information CTA2 and the restaurant information CTM_A2 are pieces of information on FFF Sichuan food.

The restaurant information CTM_A1 and the restaurant information CTM_A2 are pieces of information in message formats, and included in a chat message CTM5. The restaurant information CTM_A1 and the restaurant information CTM_A2 are displayed in the same display mode as the display mode of the chat message in the screen of the group chat. The restaurant information CTA1 and the restaurant information CTA2 are pieces of information in a banner format that includes an image, text, and a link.

In this manner, the information processing apparatus 1 identifies the plurality of personal agents PA each of which is associated with a corresponding user among the plurality of users U who are grouped, and makes an inquiry to one or more personal agents PA among the plurality of personal agents PA about the predetermined information that is used to provide a service to the group corresponding to the plurality of users U. Further, the information processing apparatus 1 provides the service to the group by using information that is provided by the one or more personal agents PA in response to the inquiry. With this configuration, the information processing apparatus 1 is able to improve convenience of service provision to the plurality of users U who are grouped.

A configuration of the information processing system that includes the information processing apparatus 1 and the terminal apparatuses 2₁ to 2ₘ that perform the above-described process will be described in detail below.

### 2. Configuration of Information Processing System

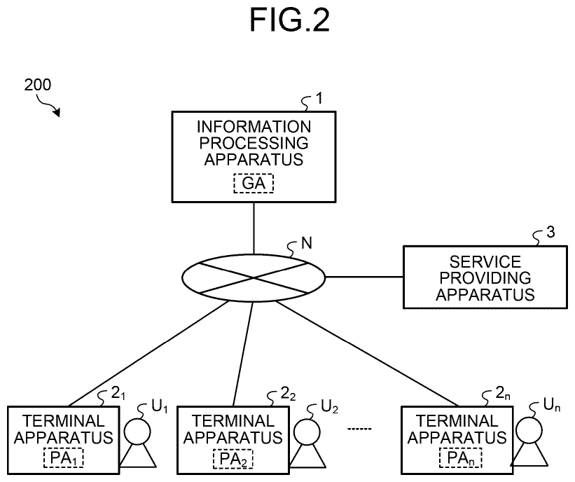

FIG. 2 is a diagram illustrating an example of a configuration of an information processing system according to one embodiment. As illustrated in FIG. 2, an information processing system 200 according to one embodiment includes the information processing apparatus 1, the plurality of terminal apparatuses 2₁, 2₂, . . . , 2ₙ, and the service providing apparatus 3. n is, for example, an integer equal to or larger than m as described above.

The plurality of terminal apparatuses 2₁, 2₂, . . . , 2ₙ are used by the different users U₁, U₂, . . . , Uₙ. The terminal apparatuses 2₁, 2₂, . . . , 2ₙ are, for example, notebook PCs, desktop PCs, smartphones, tablet PCS, wearable devices, or the like. The wearable device is, for example, smart glasses, a smart watch, or the like, but embodiments are not limited to this example.

The information processing apparatus 1, the terminal apparatuses 2₁, 2₂, . . . , 2ₙ, and the service providing apparatus 3 are communicably connected to one another in a wired or wireless manner via the network N. Meanwhile, the information processing system 200 illustrated in FIG. 2 may include the plurality of information processing apparatuses 1 and the plurality of service providing apparatuses 3, for example.

The network N includes, for example, a Wide Area Network, such as the Internet, a mobile communication network, such as Long Term Evolution (LTE), 4th Generation Mobile Communication System (4G), or 5th Generation Mobile Communication System (5G).

The terminal apparatus 2 is able to connect to the network N via a near field wireless communication, such as a mobile communication network, Bluetooth (registered trademark), or a wireless Local Area Network (LAN), and communicate with the information processing apparatus 1 and the service providing apparatus 3.

### 3. Configuration of Information Processing Apparatus 1

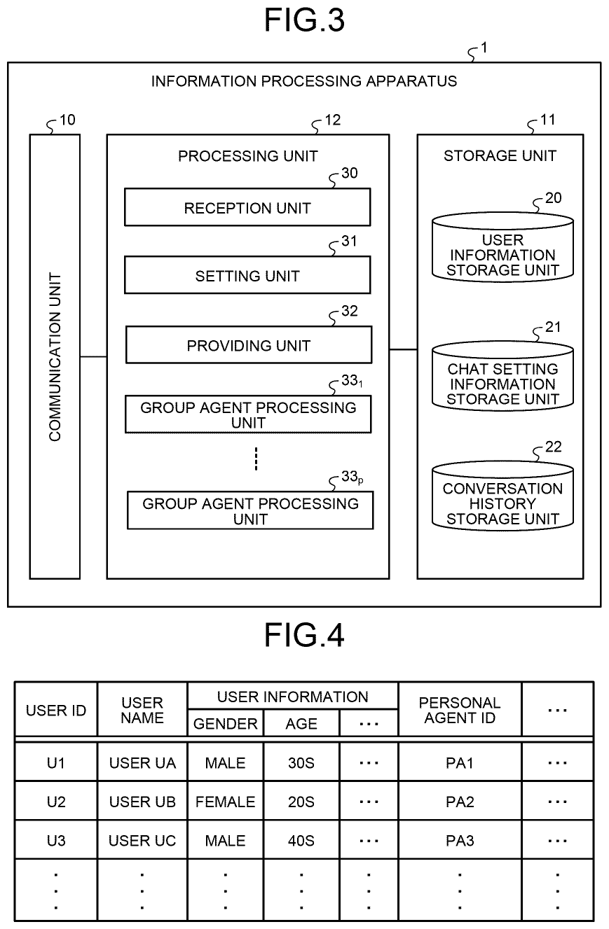

FIG. 3 is a diagram illustrating an example of a configuration of the information processing apparatus 1 according to one embodiment. As illustrated in FIG. 3, the information processing apparatus 1 includes a communication unit 10, a storage unit 11, and a processing unit 12.

### 3.1. Communication Unit 10

The communication unit 10 is implemented by, for example, a communication module, a Network Interface Card (NIC), or the like. Further, the communication unit 10 is connected to the network N in a wired or wireless manner and transmits and receives information to and from various kinds of different apparatuses. For example, the communication unit 10 transmits and receives information to and from the terminal apparatus 2 via the network N.

### 3.2. Storage Unit 11

The storage unit 11 is implemented by, for example, a semiconductor memory device, such as a Random Access Memory (RAM) or a Flash Memory, or a storage device, such as a hard disk or an optical disk. The storage unit 11 includes a user information storage unit 20, a chat setting information storage unit 21, and a conversation history storage unit 22.

### 3.2.1. User Information Storage Unit 20

The user information storage unit 20 stores therein user information including information on the user U. FIG. 4 is a diagram illustrating an example of a user information table that is stored in the user information storage unit 20 of the information processing apparatus 1 according to one embodiment. As illustrated in FIG. 4, the user information table that is stored in the user information storage unit 20 includes items of a “user ID”, a “user name”, “user information”, a “personal agent ID”, and the like.

The “user ID” is identification information for identifying the user U and is information that is assigned to each of the users U. The “user name” is a name of the user U corresponding to the “user ID”. The “user information” is attribute information and a behavior history of the user U corresponding to the “user ID”.

The attribute information on the user U includes, for example, information on a psychographic attribute, information on a demographic attribute, or the like. The demographic attribute is, for example, gender, an age, a place of residence, an occupation, or the like, and the psychographic attribute is a subject of interest, such as a travel, clothes, a vehicle, or a religion, a lifestyle, a thought, a tendency of thought, or the like.

The behavior history of the user U is a behavior history of the user U in an online service and a behavior of the user in an offline environment. The behavior history of the user U in the online service includes, for example, information on a search history, a browsing history, a post history, a purchase history, or the like.

The search history is information on a search query that was used by the user U in the past and a content that was viewed by the user U from among search results. The information on the search query is, for example, information on a search keyword, a search phrase, or the like.

The browsing history includes, for example, information that indicates a content that is viewed by the user U in the online service, and the post history includes, for example, information that indicates a content (for example, a review, a comment, or the like) that was posted in the past by the user U in the online service. The purchase history includes information on a business counterparty with whom the user U made a deal in the past.

The behavior history of the user U in an offline environment includes, for example, a movement history of the user U in an offline environment, a usage history (including a purchase history of a product or a service) of the user U in a real store, or the like, but embodiments are not limited to this example.

The “personal agent ID” is identification information for identifying the personal agent PA of the user U corresponding to the “user ID”, and is information that is assigned to each of the personal agents PA. The personal agent PA is a service agent for each of the users U as described above, and may be, for example, Auto-GPT or the like.

### 3.2.2. Chat Setting Information Storage Unit 21

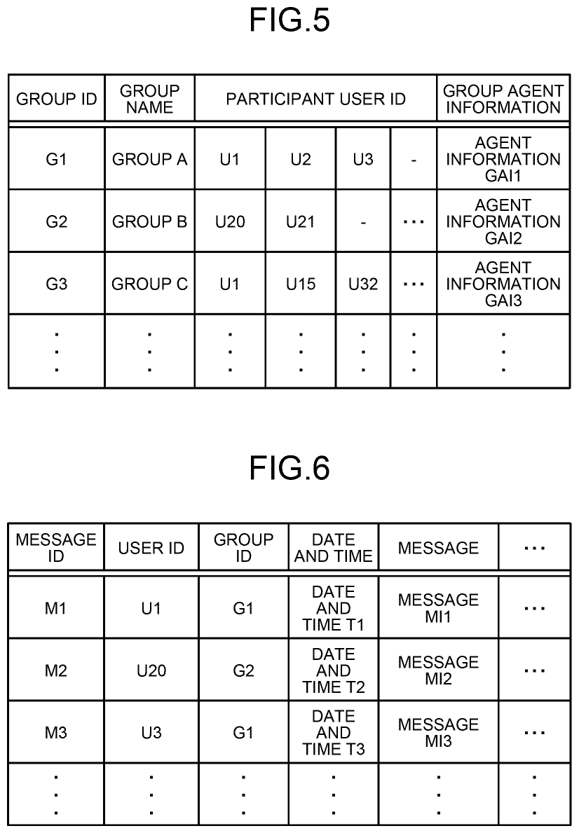

The chat setting information storage unit 21 stores therein various kinds of setting information for a chat service. FIG. 5 is a diagram illustrating an example of a chat setting information table that is stored in the chat setting information storage unit 21 of the information processing apparatus 1 according to one embodiment.

As illustrated in FIG. 5 the chat setting information table that is stored in the chat setting information storage unit 21 includes items of a “group ID”, a “group name”, a “participant user ID”, “group agent information”, and the like.

The “group ID” is an identifier for identifying a chat group and is information that is assigned to each of the chat groups. The “group name” is information that indicates a name of the chat group that is associated with the “group ID”.

The “participant user ID” includes a user ID of each of the users U who participates in the chat group that is associated with the “group ID”. The “group agent information” is information on the group agent GA of the chat group that is associated with the “group ID”, and includes an agent ID, setting information, stored information, or the like of the group agent GA. The group agent GA is, for example, a service agent for each of the groups, and may be, for example, Auto-GPT or the like. Further, the group agent GA may be, for example, a service agent that is assigned to a plurality of groups.

Meanwhile, for example, the chat setting information table illustrated in FIG. 6 includes, as the setting information other than the chat group, setting information on a one-to-one chat, setting information on a one-to-many chat, or the like, although not illustrated in the drawing.

### 3.2.3. Conversation History Storage Unit 22

The conversation history storage unit 22 stores therein various kinds of conversation histories in the chat service. FIG. 6 is a diagram illustrating an example of a conversation history table that is stored in the conversation history storage unit 22 of the information processing apparatus 1 according to one embodiment. As illustrated in FIG. 6, the conversation history table that is stored in the conversation history storage unit 22 includes items of a “message ID”, a “user ID”, a “group ID”, “date and time”, a “message”, and the like.

The “message ID” is an identifier for identifying a chat message, and is information that is assigned to each of chat messages. The “user ID” is a user ID of the user U who has posted the chat message corresponding to the “message ID”. The “group ID” is a group ID of a chat group corresponding to a chat room in which the chat message corresponding to the “message ID” is posted.

The “date and time” is information that indicates a date and time at which the chat message corresponding to the “message ID” is posted. The “message” is the chat message corresponding to the “message ID”. Meanwhile, for example, the chat setting information table illustrated in FIG. 6 includes, as the conversation history other than the chat group, a conversation history in a one-to-one chat, a conversation history in a one-to-many chat, or the like, although not illustrated in the drawing.

### 3.3. Processing Unit 12

The processing unit 12 is a controller, and implemented by, for example, causing a processor, such as a Central Processing Unit (CPU) or a Micro Processing Unit (MPU), to execute various kinds of programs (corresponding to one example of an information processing program) that are stored in a storage device in the information processing apparatus 1 by using a RAM or the like as a work area.

Further, the processing unit 12 is a controller, and may be implemented by, for example, an integrated circuit, such as an Application Specific Integrated Circuit (ASIC), a Field Programmable Gate Array (FPGA), or a General Purpose Graphic Processing Unit (GPGPU).

As illustrated in FIG. 3, the processing unit 12 includes a reception unit 30, a setting unit 31, a providing unit 32, and group agent processing units 33₁ to 33ₚ and implements or performs functions and operation of information processing as described below. p indicates the number of group agents and is an integer equal to or larger than two.

Meanwhile, an internal configuration of the processing unit 12 is not limited to the configuration as illustrated in FIG. 3, and it is possible to adopt a different configuration as long as the information processing to be described below is performed. Further, in the following, when each of the group agent processing units 33₁ to 33ₚ is described without being individually distinguished, each of the group agent processing units 33₁ to 33ₚ may be described as a group agent processing unit 33.

### 3.3.1. Reception Unit 30

The reception unit 30 receives various kinds of information. For example, the reception unit 30 receives a post request that is transmitted from the terminal apparatus 2. The post request includes information on a chat message, a group ID, a user ID, or the like. The reception unit 30 updates the conversation history table that is stored in the conversation history storage unit 22 based on the post request.

Furthermore, the reception unit 30 receives a chat group setting request that is transmitted from the terminal apparatus 2. The chat group setting request is a request for setting of a group of the plurality of users U for a group chat among the plurality of users U, and includes user IDs of the plurality of users U who are grouped, a name of the group, or the like.

Moreover, the reception unit 30 receives a user addition request that is transmitted from the terminal apparatus 2. The user addition request includes the group ID and a user ID of the user U who is added from the group among the plurality of users U who are grouped as the group with the group ID.

Furthermore, the reception unit 30 receives a user delete request that is transmitted from the terminal apparatus 2. The user addition request includes the group ID and a user ID of the user U who is excluded to the group among the plurality of users U who are grouped in the group with the group ID.

### 3.3.2. Setting Unit 31

When the reception unit 30 receives a group setting request, the setting unit 31 sets group information that is included in the group setting request based on the group setting request. The group information includes a group ID, a group name, a participant user ID, and group agent information.

For example, the setting unit 31 adds the group information to the chat setting information table that is stored in the chat setting information storage unit 21 based on the chat group setting request that is received by the reception unit 30.

Furthermore, the setting unit 31 updates the group information in the chat setting information table based on the user addition request that is received by the reception unit 30. Moreover, the setting unit 31 updates the group information in the chat setting information table based on the user delete request that is received by the reception unit 30.

### 3.3.3. Providing Unit 32

The providing unit 32 provides various kinds of information. For example, the providing unit 32 transmits a chat message that is included in the post request that is received by the reception unit 30 to the terminal apparatus 2 which is different from the terminal apparatus 2 that has transmitted the post request and which is the terminal apparatus 2 of the user U to whom the chat message is transmitted.

### 3.3.4. Group Agent Processing Unit 33

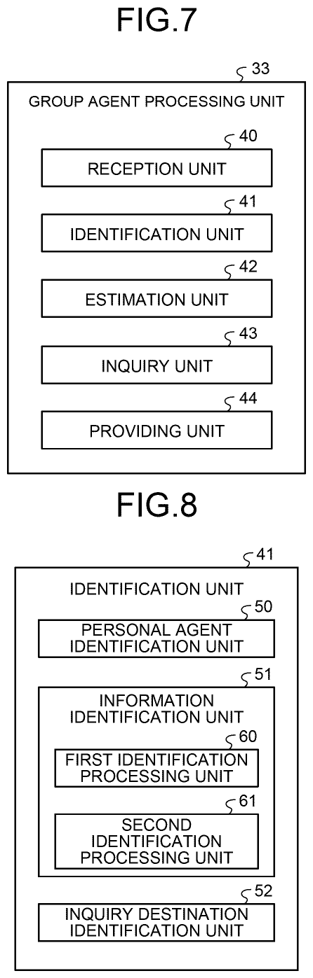

The group agent processing unit 33 implements functions of the group agent. FIG. 7 is a diagram illustrating an example of a configuration of the group agent processing unit 33 in the processing unit 12 of the information processing apparatus 1 according to one embodiment.

As illustrated in FIG. 7, the group agent processing unit 33 includes a reception unit 40, an identification unit 41, an estimation unit 42, an inquiry unit 43, and a providing unit 44. Each of the reception unit 40, the identification unit 41, the estimation unit 42, the inquiry unit 43, and the providing unit 44 will be described in detail below.

### 3.3.4.1. Reception Unit 40

The reception unit 40 receives various kinds of information. The reception unit 40 receives the input information that is information input by the user U.

The reception unit 40 receives the input information that includes, for example, information on a service from the user U. For example, the reception unit 40 receives the input information including a chat message that is posted by the user U and that includes the information on the service.

The information on the service is information on a service that is provided by the service providing apparatus 3, but may be information on a service that is provided by a different service providing apparatus other than the service providing apparatus 3.

### 3.3.4.2. Identification Unit 41

The identification unit 41 performs various kinds of identification. FIG. 8 is a diagram illustrating an example of a configuration of the identification unit 41 in the group agent processing unit 33 of the information processing apparatus 1 according to one embodiment. As illustrated in FIG. 8, the identification unit 41 includes a personal agent identification unit 50, an information identification unit 51, and an inquiry destination identification unit 52.

The personal agent identification unit 50 identifies the plurality of personal agents PA each of which is associated with a corresponding user in the plurality of users U who are grouped. For example, the personal agent identification unit 50 identifies, as the personal agent of the user U, a personal agent of a chat application in which the user ID of the user U is set. The user ID is an account of the user U, which is set in the chat application.

The personal agent identification unit 50 identifies the plurality of personal agents PA of the plurality of users U who are grouped, for each of the groups, based on the user information table that is stored in the user information storage unit 20 and the chat setting information table that is stored in the chat setting information storage unit 21.

When the user information table is in the state as illustrated in FIG. 4 and the chat setting information table is in the state as illustrated in FIG. 5, the user IDs of the plurality of users U who are grouped as the group A are “U1”, “U2”, and “U3”. Therefore, the personal agent identification unit 50 identifies, as the personal agents PA of the group A, personal agents PA₁, PA₂, and PA₃ with personal agent IDs of PA1, PA2, and PA3.

The information identification unit 51 identifies the predetermined information that is used to provide a service to the group to which the user U who has input the input information belongs, based on the input information that is received by the reception unit 40.

For example, the information identification unit 51 identifies the predetermined information that is used to provide a service to a group in a chat room in which the user U has input the input information, based on the input information that is received by the reception unit 40.

The information identification unit 51 performs a process for identifying the predetermined information regardless of whether or not the input information that is received by the reception unit 40 includes the information on the service, but embodiments are not limited to this example.

For example, the information identification unit 51 is able to perform a process for identifying predetermined information only when the input information that is received by the reception unit 40 includes a specific term or a specific phrase, or perform a process for identifying predetermined information only when the input information that is received by the reception unit 40 does not include a specific term or a specific phrase.

The information identification unit 51 includes a first identification processing unit 60 and a second identification processing unit 61. The first identification processing unit 60 identifies a type of a service and values of one or more parameters among a plurality of parameters that are used to provide the service of this type, based on the input information that is received by the reception unit 40.

The type of the service is, for example, the restaurant search service, the hotel search service, the restaurant reservation service, the hotel reservation service, the advertisement distribution service, the map information providing service, the electronic commerce service, or the like, but embodiments are not limited to this example.

A plurality of parameters that are used to provide the service include a mandatory parameter that is a parameter needed to provide the service and an additional parameter that is a parameter to increase accuracy of service provision.

When the service type is the restaurant search service, the mandatory parameter is, for example, an area of a restaurant, scheduled date and time of eating out, the number of people, or the like, and the additional parameter is a genre of food, a price range, a seat (terrace, table, tatami room), a facility (a wheelchair or pets allowed), evaluation, allergic ingredients, display order, maximum number of acquisitions or the like, but embodiments are not limited to this example.

Furthermore, when the service type is the hotel search service, the mandatory parameter is, for example, an area of a hotel, scheduled date and time of stay, the number of people, or the like, and the additional parameter is the number of rooms, the number of adults, the number of children, evaluation, a price range, facilities/services (wifi, Japanese-style room/Western-style room, double bed, single bed, no smoking, smoking), display order, maximum number of acquisitions or the like, but embodiments are not limited to this example.

Moreover, when the service type is the restaurant reservation service, the mandatory parameter is, for example, an area of a restaurant, scheduled date and time of eating out, the number of people, or the like, and the additional parameter is a genre of food, a seat (terrace, table, tatami room), allergic ingredients, display order, maximum number of acquisitions or the like, but embodiments are not limited to this example.

Furthermore, when the service type is the hotel reservation service, the mandatory parameter is, for example, an area of a hotel, scheduled date and time of stay, the number of people, or the like, and the additional parameter is the number of rooms, the number of adults, the number of children, a price range, a room type, facilities/services (wifi, Japanese-style room/Western-style room, double bed, single bed, no smoking, smoking), display order, maximum number of acquisitions, or the like, but embodiments are not limited to this example.

The first identification processing unit 60 is able to identify values of a plurality of parameters that are used to provide the service, and identifies a value of a parameter for which the value is identifiable from the input information that is received by the reception unit 40 from among the plurality of parameters, for example.

For example, when it is possible to identify values of one or more mandatory parameters based on the input information that is received by the reception unit 40, the first identification processing unit 60 identifies the values of one or more mandatory parameters. Furthermore, when it is possible to identify values of one or more additional parameters based on the input information that is received by the reception unit 40, the first identification processing unit 60 identifies the values of one or more additional parameters.

The first identification processing unit 60 identifies, with use of the generative AI, a service type and values of one or more parameters among a plurality of parameters that are used to provide a service of this service type based on the information on the service received by the reception unit 40, for example.

The generative AI is, for example, text generative AI. The text the generative AI is, for example, Large Language Models that are trained to estimate and output a next token from an input token string, and is, for example, a transformer-based model, an RNN-based model, or the like. Examples of the transformer-based model include a GPT, but embodiments are not limited to this example. Examples of the RNN-based model include a RWKV, but embodiments are not limited to this example.

Meanwhile, the generative AI may be a language model that is trained (for example, fine-tuning) exclusively for generating answer information. The generative AI is arranged in an external information processing apparatus, and the first identification processing unit 60 uses the generative AI via an API; however, the generative AI may be arranged in the information processing apparatus 1.

The first identification processing unit 60 is able to input, to the generative AI, information that includes the instruction information and the chat message that is received as the input information by the reception unit 40, and cause the generative AI to output the service type and values of one or more parameters. The instruction information is information for instructing the generative AI to identify a service type and values of one or more parameters that are used to provide a service of the service type from the chat message that is received as the input information by the reception unit 40.

The instruction information includes, for example, information on a character string of “Please identify a type of a service and a value of a parameter that is used to provide the service of this type from the following message. Please identify the type of the service from a service type list below, and identify the value of the parameter from a parameter list below. Please output an identification result in an output format below.”, and information on the service type list, the parameter list, and the output format.

The service type list includes, for example, information in which a service type and information indicating a content of a service are associated with each other for each of service types. The parameter list includes, for each of the service types, information in which a parameter and information indicating a content of the parameter are associated with each other for each of parameters, for example. Meanwhile, the instruction information is not limited to the example as described above, and may be any information as long as it is possible to output a type of a service and a value of a parameter that is used to provide the service of this type from a message.

Furthermore, when the generative AI is a GPT that is provide by OpenAI, it is possible to cause the generative AI to output the service type and values of one or more parameters by using a function calling function. In this case, information that is input to the generative AI includes, for each of the service types, information that indicates a definition of a service type, information that indicates a definition of each parameter, or the like.

Moreover, when the generative AI is fine-tuned so as to output a type of the service and a value of a parameter that is used to provide the service of this type from a message, the input information that is input to the generative AI need not always include the instruction information.

Furthermore, the first identification processing unit 60 may be configured to identify the type of the service and the value of the parameter that is used to provide the service of this type from the message by a well-known slot filling technology without using the generative AI.

The second identification processing unit 61 identifies, as predetermined information, information on an unidentified parameter that is a parameter for which a value is not yet identified by the first identification processing unit 60 among the plurality of parameters that correspond to the service type that is identified by the first identification processing unit 60.

The second identification processing unit 61 identifies a plurality of parameters that are associated with the service type that is identified by the first identification processing unit 60. The second identification processing unit 61 stores therein, for each of the services, the service type and the plurality of parameters in an associated manner. The plurality of parameters include the mandatory parameter and the additional parameter as described above.

The second identification processing unit 61 identifies a plurality of parameters that are associated with the service type that is identified by the first identification processing unit 60 from among the stored service types of the respective services and the plurality of parameters for each of the service types.

For example, the second identification processing unit 61 identifies, as the unidentified parameter, a mandatory parameter for which a value is not yet identified by the first identification processing unit 60 from among the plurality of parameters that are associated with the service type that is identified by the first identification processing unit 60. Furthermore, the second identification processing unit 61 may identify, as the unidentified parameter, an unidentified additional parameter, in addition to the mandatory parameter for which the value is not yet identified from among the plurality of parameters.

Moreover, when the instruction information is set such that the generative AI outputs information on a parameter for which a value is not yet identified, the second identification processing unit 61 may identify an unidentified parameter from among the plurality of parameters that are associated with the service type that is identified by the first identification processing unit 60 based on the information that is output from the generative AI.

The inquiry destination identification unit 52 identifies one or more personal agents PA based on the predetermined information that is identified by the information identification unit 51.

For example, when the predetermined information that is identified by the second identification processing unit 61 is information on all of the users U in the group, the inquiry destination identification unit 52 identifies, as the target personal agents TPA, the personal agents PA of all of the users in the group.

Furthermore, as for PA₁, PA₂, . . . , PAₘ, when the predetermined information that is identified by the second identification processing unit 61 is information on a certain user U among the plurality of users U who belong to the group, the personal agent PA of the certain user U is identified as the target personal agent TPA.

The inquiry destination identification unit 52 identifies, as the target personal agent TP, the personal agent PA of the user U other than the user U for whom the value of the parameter corresponding to the predetermined information is already acquired among the plurality of users U who belong to the group, for example.

Furthermore, the inquiry destination identification unit 52 stores therein information on the personal agent PA that serves as an inquiry destination for each of the parameters, and may identify, as the target personal agent TP, a personal agent PA that is associated with the parameter corresponding to the predetermined information.

### 3.3.4.3. Estimation Unit 42

The estimation unit 42 performs various kinds of estimation. The estimation unit 42 estimates a situation of the group in the chat room by using the generative AI based on the message history of the plurality of users U in the chat room.

The situation of the group is a type of a topic in the group, a depth of the topic in the group, an atmosphere of the group, a hierarchical relationship of the users U in the group, a degree of intimacy in the group, a degree of humor, or the like, but embodiments are not limited to this example.

The estimation unit 42 inputs, as the input information, information that includes the message history of the plurality of users U in the chat room and instruction information for instructing estimation of the situation of the group to the generative AI, and causes the generative AI to estimate the situation of the group in the chat room, for example.

The instruction information includes, for example, information on a character string of “Given message history is a message history of the plurality of users U in the chat room. Please estimate the situation of the group in the chat room based on the message history. The situation is defined as follows.” and definition information on the situation.

Meanwhile, the instruction information may include information that indicates an example in which an exemplary message history and an exemplary situation are associated with each other, with which it is possible to cause the generative AI to estimate a situation with accuracy. Furthermore, the generative AI may be generative AI that is trained by fine tuning or the like by using a data set of the message history of the plurality of users U and the situation, and, in this case, input information that is input to the generative AI need not always include instruction information.

Furthermore, the estimation unit 42 estimates a characteristic of the group by using the generative AI based on attribute information on the plurality of users U in the chat room. For example, the estimation unit 42 estimates, as the characteristic of the group, a persona of the chat group based on the attribute information on the plurality of users U who belong to the chat group.

For example, the estimation unit 42 estimates, as a persona of the group A, a common characteristic among the plurality of users U based on the attribute information on the plurality of users U. The common characteristic among the plurality of users U is, for example, a common attribute, a common interest, or a common behavior pattern among the plurality of users U, but embodiments are not limited to this example.

The common attribute is, for example, an age group, gender, a family structure, an occupation, or the like, but embodiments are not limited to this example. The common interest is, for example, a vehicle lover, a shopping lover, a travel lover, or the like, but embodiments are not limited to this example. The common behavior pattern is, for example, traveling once or more in a month, eating out for dinner three times or more on weekdays, going shopping every weekend, or the like, but embodiments are not limited to this example.

The estimation unit 42 is able to determine, as the persona of the group, various kinds of interests or lack of interests of the group, the number of people in the group A, an age group of the group A (for example, an age group or an average age group from the youngest to the oldest, or the like), gender of the group, or the like, for example.

The persona of the chat group is, for example, a group of four male corporate workers who are in their 40s and who love grilled meat, a group of three male college students who love travel to Osaka, a group of a total of 16 people who are in there 20s to 40s and who love a specific restaurant, or the like, but embodiments are not limited to this example.

### 3.3.4.4. Inquiry Unit 43

The inquiry unit 43 makes various kinds of inquiries to the personal agent PA.

The inquiry unit 43 makes an inquiry to one or more personal agents PA, which are identified as the target personal agents TPA by the inquiry destination identification unit 52 among the plurality of personal agents PA that are identified by the personal agent identification unit 50, about the predetermined information that is used to provide a service to a group corresponding to the plurality of users U.

When inquiring the predetermined information, the inquiry unit 43 provides information that indicates the estimation result obtained by the estimation unit 42 to one or more personal agents. The estimation result obtained by the estimation unit 42 is, for example, one or both of the characteristic of the group and the situation of the group in the chat room.

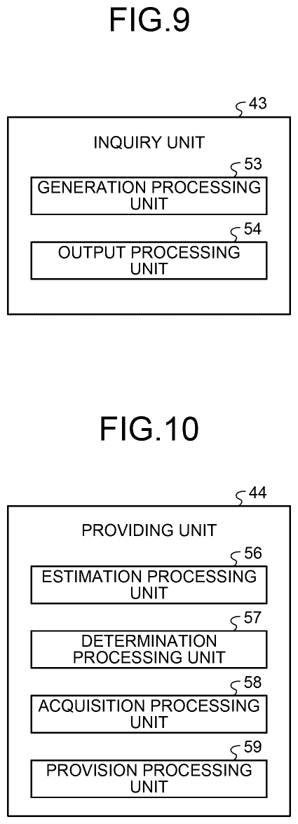

FIG. 9 is a diagram illustrating an example of a configuration of the inquiry unit 43 in the group agent processing unit 33 of the information processing apparatus 1 according to one embodiment. As illustrated in FIG. 9, the providing unit 44 includes a generation processing unit 53 and an output processing unit 54.

The generation processing unit 53 generates, with use of the generative AI, inquiry information that indicates a sentence for inquiring the predetermined information that is identified by the information identification unit 51. For example, the generation processing unit 53 inputs, to the generative AI, information that includes instruction information that is information for instructing generation of a sentence for inquiring the value of the unidentified parameter that is identified by the information identification unit 51, and causes the generative AI to generate inquiry information.

When the service type that is identified by the information identification unit 51 is the restaurant search service and the unidentified parameter that is identified by the information identification unit 51 is the genre of food, the instruction information that is input to the generative AI includes, for example, information on a character string of “Please generate a sentence for inquiring the genre of food for searching for restaurants that are available for reservation”.

The generation processing unit 53 has, for each of the service types, information in which instruction information is associated with each of the parameters, identifies the instruction information corresponding to the unidentified parameter that is identified by the information identification unit 51, inputs information including the identified instruction information to the generative AI, and causes the generative AI to generate the inquiry information.

Furthermore, the generation processing unit 53 may have, for each of the service types, information in which inquiring information is associated with each of the parameters, and may identify the inquiry information corresponding to the unidentified parameter that is identified by the information identification unit 51.

For example, when the service type that is identified by the information identification unit 51 is the restaurant search service and the unidentified parameter that is identified by the information identification unit 51 is the genre of food, the inquiry information is, for example, information on a character string of “Restaurants that are available for reservation are to be searched for. What genre of restaurant do you like?”, but embodiments are not limited to this example.

Furthermore, when the information that is used to determine the value of the unidentified parameter is information for generating a persona of the group, the generation processing unit 53 generates or determines, as the inquiry information, information for inquiring the attribute information on the user U.

The output processing unit 54 outputs the inquiry information that is generated by the generation processing unit 53 to the target personal agents TPA that are one or more personal agents PA. The output processing unit 54 transmits the inquiry information that is generated by the generation processing unit 53 to the terminal apparatus 2 including the target personal agent TPA via the communication unit 10, and outputs the inquiry information to the target personal agent TPA.

In the terminal apparatus 2, the target personal agent TPA has the information on the user U and is able to generate the answer information based on the information on the user U. The information on the user U includes information on the attribute of the user U, information on the schedule of the user U, information on the behavior pattern of the user U, or the like. For example, the target personal agent TPA generates the answer information that includes the information on the user U of a certain type corresponding to the inquiry information.

The target personal agent TPA inputs, as the input information, information that includes the inquiry information and the instruction information to the generative AI, and causes the generative AI to identify a type of the information on the user U that is needed by the inquiry information. The instruction information includes a sentence for instructing identification of the type of the information on the user U that is needed by the inquiry information. The type of the information on the user U is, for example, an age, gender, a place of residence, an occupation, a type of an interest, a type of a behavior pattern, or the like of the user U, but embodiments are not limited to this example.

Furthermore, the target personal agent TPA may have the information identification list that includes the type of the information on the user U and one or more characteristic words, and may identify, as the information on the user U that is needed by the inquiry information, a certain type of information corresponding to the characteristic word that is included in the inquiry information from among characteristic words in the information identification list.

The target personal agent TPA has, for each type of the service, the answer possibility information that indicates whether or not an answer is possible for each type of the information on the user U for example, and the answer possibility information is set by, for example, the user U of the terminal apparatus 2 that includes the target personal agent TPA.

The target personal agent TPA generates the answer information that includes information on an unidentified parameter when the answer possibility information includes setting indicating that an answer to the identified type of the information on the user U is possible, and generates the answer information indicating that the answer is impossible in other cases. The target personal agent TPA generates the answer information that includes the identified type of the information on the user U, and outputs the generated answer information to the group agent GA.

The target personal agent TPA may make an inquiry to the user U if it is possible to provide the answer information, and provide the answer information based on an answer that is given by the user U. For example, when the user U permits to provide the answer information, the target personal agent TPA provides the answer information.

The target personal agent TPA may include, for each type of the service, for example, the inquiry necessity information that indicates necessity of an inquiry to the user U for each type of the information on the user U, for example. The inquiry necessity information is set by, for example, the user U of the terminal apparatus 2 that includes the target personal agent TPA.

In this case, when the inquiry necessity information includes setting indicating that an inquiry about the identified type of the information on the user U needs to be made to the user U, an inquiry message for inquiring if it is allowed to output the answer information including the identified type of the information on the user U, in the display area of the terminal apparatus 2.

When the user U inputs positive information (for example, information on a character string of “Yes”, information on a character string of “OK”, or the like) in response to the inquiry message that is displayed in a pop-up manner, the target personal agent TPA outputs the generated answer information to the group agent GA.

Furthermore, the output processing unit 54 may provide information indicating the estimation result obtained by the estimation unit 42 to one or more personal agents when inquiring the predetermined information. The estimation result obtained by the estimation unit 42 is, for example, one or both of the characteristic of the group and the situation of the group in the chat room.

The target personal agent TPA has the answer possibility information that indicates whether or not an answer is possible for each of characteristic of the group or for each of situations, and determines whether to generate the answer information including information on an unidentified parameter based on the estimation result that is obtained by the estimation unit 42.

For example, the target personal agent TPA generates the answer information that includes information on an unidentified parameter when the answer possibility information setting indicating that an answer is possible with respect to the characteristic of the group or the situation estimated by the estimation unit 42, and generates the answer information indicating that the answer is impossible in other cases.

Furthermore, the target personal agent TPA has, for each of the characteristic of the group or for each of the situations, the inquiry necessity information that indicates necessity of an inquiry to the user U, and inquires if it is possible to output the answer information including the identified type of the information on the user U based on the estimation result obtained by the estimation unit 42.

Moreover, the target personal agent TPA may have information indicating a type of information for which an answer is possible for each combination of one or more the characteristic of the group and the situations, and may output the answer information that includes information of the type for which the answer is possible in accordance with the characteristic of the group and the situation indicated by the estimation result that is obtained by the estimation unit 42.

### 3.3.4.5. Providing Unit 44

The providing unit 44 provides various kinds of information. The providing unit 44 provides a service to the group by using information that is provided by one or more personal agents PA in response to an inquiry that is made by the inquiry unit 43.

FIG. 10 is a diagram illustrating an example of a configuration of the providing unit 44 in the group agent processing unit 33 of the information processing apparatus 1 according to one embodiment. As illustrated in FIG. 10, the providing unit 44 includes an estimation processing unit 56, a determination processing unit 57, an acquisition processing unit 58, and a provision processing unit 59.

The estimation processing unit 56 estimates a situation of the group in the chat room by using the generative AI based on the message history of the plurality of users U in the chat room. The estimation processing unit 56 estimates the situation of the group in the chat room through the same processes as the estimation unit 42.

Furthermore, the estimation processing unit 56 estimates the characteristic of the group in the chat room by using the generative AI based on the pieces of attribute information on the plurality of users U in the chat room. The estimation processing unit 56 estimates the characteristic of the group through the same processes as the estimation unit 42.

Moreover, the estimation processing unit 56 may estimate the persona of the group based on the answer information that is output from the target personal agent TPA. For example, when the answer information is information on the attribute of each of the users U in the group, the estimation processing unit 56 estimates the persona of the group based on the attribute information on each of the users U through the same processes as the estimation unit 42.

The determination processing unit 57 determines the value of the unidentified parameter based on information that is provided by one or more personal agents in response to an inquiry that is made by the inquiry unit 43.

For example, when the unidentified parameter is the genre of food, the determination processing unit 57 determines the value of the unidentified parameter based on the genre of food that each of the users U prefers, in the answer information that is output from each of the target personal agents TPA. For example, the determination processing unit 57 determines, as the value of the unidentified parameter, a genre of food that a predetermined percentage or more (for example, 50% or more) of the users U among the plurality of users U who belong to the group commonly prefer.

When information corresponding to the inquiry that is made by the inquiry unit 43 is not provided by one or more personal agents PA, the determination processing unit 57 determines the value of the unidentified parameter based on the estimation result that is obtained by the estimation processing unit 56.

The determination processing unit 57 is able to determine the value of the unidentified parameter based on, for example, the persona of the group that is estimated by the estimation processing unit 56. For example, it is assumed that the service type that is identified by the information identification unit 51 is the restaurant search service, the persona of the group that is estimated by the estimation processing unit 56 is a group of four men who are in their 40s and who love grilled meat, and unidentified parameters are the number of people and the genre of food. In this case, the determination processing unit 57 determines that the parameter of the number of people is set to four and the parameter of the genre of food is set to grilled meat.

Furthermore, the determination processing unit 57 is able to determine the value of the unidentified parameter based on, for example, the situation of the group that is estimated by the estimation processing unit 56. For example, it is assumed that the service type that is identified by the information identification unit 51 is the restaurant search service, the type of the topic in the group that is estimated by the estimation processing unit 56 is Chinese food, and the unidentified parameter is the genre of food. In this case, the determination processing unit 57 determines that the parameter of the genre of food is set to Chinese food.

Moreover, it is assumed that the service type that is identified by the information identification unit 51 is the restaurant search service, the degree of intimacy in the group that is estimated by the estimation processing unit 56 is a high degree of intimacy, and the unidentified parameter is the genre of food. In this case, the determination processing unit 57 determines that the parameter of the genre of food is Japanese style pub food. Furthermore, when the degree of intimacy in the group is low, the determination processing unit 57 determines that the parameter of the genre of food is a coffee shop.

The acquisition processing unit 58 acquires, from a service providing apparatus that provides a service, service information that is information on a service based on values of a plurality of parameters including the value of the unidentified parameter that is determined by the determination processing unit 57 and based on the type of the service that is identified by the first identification processing unit 60.

For example, when the service type that is identified by the information identification unit 51 is the restaurant search service, the acquisition processing unit 58 designates the restaurant search service, and transmits a search request that includes values of an area of a restaurant, a genre of food, scheduled date and time of eating out, and the number of people to the service providing apparatus 3 via the API of the service providing apparatus 3.

The service providing apparatus 3 searches for a plurality of restaurants in accordance with the search request, and acquires a search result as the information on the service of the service type that is identified by the information identification unit 51. The search result includes, for example, information on a name, a place, a category, information such as an introduction text, or the like of each of the retrieved restaurants, but embodiments are not limited to this example.

Furthermore, when the service type that is identified by the information identification unit 51 is the hotel reservation service, the acquisition processing unit 58 designates the hotel reservation service, and transmits a reservation request that includes values of an area of a hotel, scheduled date and time of stay, and the number of people to the service providing apparatus 3 via the API of the service providing apparatus 3.

The service providing apparatus 3 performs a reservation process in accordance with the reservation request, and acquires a result of the reservation process as the information on the service of the service type that is identified by the information identification unit 51. The result of the reservation process includes, for example, information on a character string of “Reservation is completed”, information on reservation details, and the like, but embodiments are not limited to this example.

The provision processing unit 59 provides the service information that is acquired by the acquisition processing unit 58 to the group. The provision processing unit 59 transmits the service information that is acquired by the acquisition processing unit 58 to the terminal apparatuses 2 of the users U who belong to the group, and provides the service information that is acquired by the acquisition processing unit 58 to the group.

When receiving the service information from the provision processing unit 59, the terminal apparatus 2 displays the received service information as a chat message in the chat room of the group. Furthermore, the terminal apparatus 2 may display the received service information in the chat room in a different format from the chat message, or display the received service information in a pop-up window that is superimposed on the chat room.

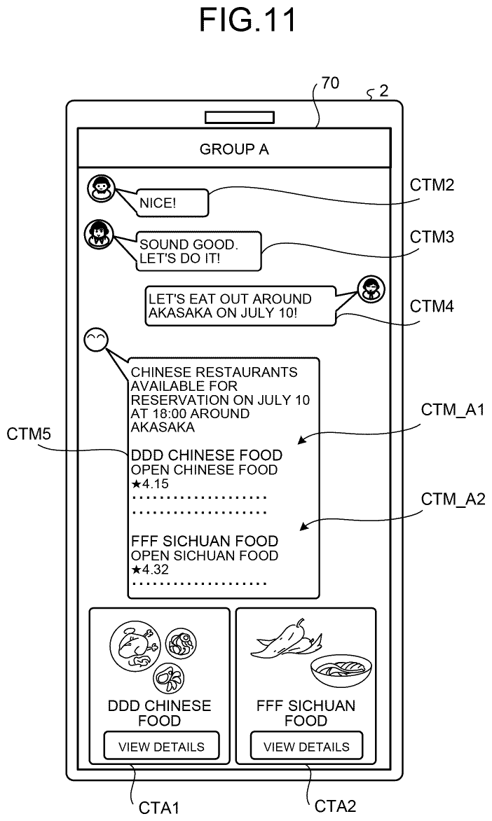

FIG. 11 is a diagram illustrating an example of the service information that is provided to the terminal apparatus 2 by the providing unit 44 in the processing unit 12 of the information processing apparatus 1 according to one embodiment and that is displayed on the terminal apparatus 2. A screen 70 of the chat room illustrated in FIG. 11 is a chat room screen of the group A.

In the example illustrated in FIG. 11, in the chat room of the group A in the screen 70 of the chat room, the restaurant information CTA1, the restaurant information CTA2, the restaurant information CTM_A1, and the restaurant information CTM_A2 are displayed. The restaurant information CTA1 and the restaurant information CTM_A1 are pieces of information on DDD Chinese food, and the restaurant information CTA2 and the restaurant information CTM_A2 are pieces of information on FFF Sichuan food.

The restaurant information CTM_A1 and the restaurant information CTM_A2 are pieces of information in message formats, and included in a chat message CTM9. The restaurant information CTM_A1 and the restaurant information CTM_A2 are displayed in the same display mode as the display mode of the chat message in the screen of the group chat. The restaurant information CTA1 and the restaurant information CTA2 are pieces of information in a banner format that includes an image, text, and a link.

### 4. Flow of Processes

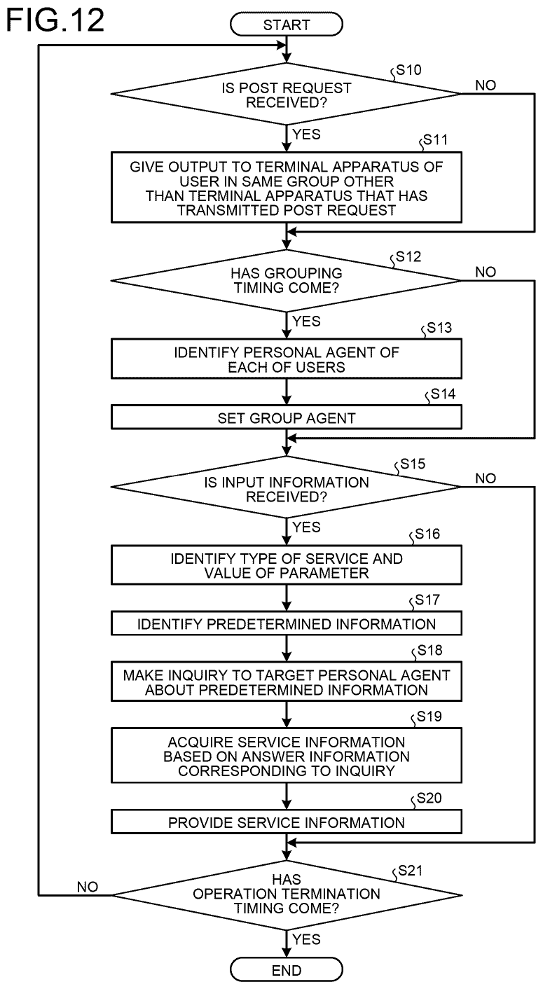

A flow of information processing that is performed by the processing unit 12 of the information processing apparatus 1 according to one embodiment will be described below. FIG. 12 is a flowchart illustrating an example of the information processing that is performed by the processing unit 12 of the information processing apparatus 1 according to one embodiment.

As illustrated in FIG. 12, the processing unit 12 of the information processing apparatus 1 determines whether or not a post request is received (Step S10). When it is determined that the post request is received (Step S10: Yes), the processing unit 12 gives output to the terminal apparatuses 2 of the users U in the same group other than the terminal apparatus 2 that has transmitted the post request (Step S11).

Subsequently, when the process in Step S11 is terminated or when it is determined that the post request is not received (Step S10: No), the processing unit 12 determines whether or not a grouping timing has come (Step S12). The processing unit 12 determines that the grouping timing has come when, for example, receiving the chat group setting request.

When it is determined that the grouping timing has come (Step S12: Yes), the processing unit 12 identifies the personal agent PA of each of the users U who are grouped (Step S13), and sets the group agent GA of the group (Step S14).

When the process in Step S11 is terminated or when it is determined that the grouping timing has not yet come (Step S12: No), the processing unit 12 determines whether or not input information is received from the user U in the group (Step S15).

When it is determined that the input information is received (Step S15: Yes), the processing unit 12 identifies a type of a service and a value of a parameter based on the input information (Step S16). Furthermore, the processing unit 12 identifies the predetermined information based on the type of the service and the value of the parameter that are identified in Step S16 (Step S17), and makes an inquiry to the identified target personal agent about the predetermined information (Step S18).

The processing unit 12 acquires the service information based on the answer information corresponding to the inquiry that is made in Step S18 (Step S19). Further, the processing unit 12 provides the service information that is acquired in Step S19 (Step S20).

When the process in Step S20 is terminated or when it is determined that the input information is not received (Step S15: No), the processing unit 12 determines whether or not an operation termination timing has come (Step S21). The processing unit 12 determines that the operation termination timing has come when, for example, the power supply of the information processing apparatus 1 is turned off.

When the processing unit 12 determines that the operation termination timing has not yet come (Step S21: No), the process goes to Step S10, and when the processing unit 12 determines that the operation termination timing has come (Step S21: Yes), the process illustrated in FIG. 12 is terminated.

### 5. Modifications

The chat group has been described above as an example of the group of the users U, but the processing unit 12 of the information processing apparatus 1 is able to perform the same processes for a group other than the chat group.

A part or all of the functions of the service providing apparatus 3 as described above may be implemented by the information processing apparatus 1. For example, the information processing apparatus 1 may be configured to include a part or whole of the service providing apparatus 3 as described above, instead of the information processing apparatus 1.

Furthermore, a part or all of the functions of the information processing apparatus 1 as described above may be implemented by one of the terminal apparatuses 2 of the plurality of users U who are included in the group. For example, the terminal apparatus 2 may be configured to include a part or whole of the information processing apparatus 1 as described above, instead of the terminal apparatus 2.

Moreover, the setting unit 31 may set the answer possibility information and the inquiry necessity information based on the attribute information on the user U. With this configuration, the answer possibility information and the inquiry necessity information are set in accordance with the attribute of the user U.

In the example as described above, the processing unit 12 of the information processing apparatus 1 makes an inquiry to one or more personal agents among the plurality of personal agents that are associated with the plurality of users U who are grouped about the predetermined information that is used to provide a service to the group, but embodiments are not limited to this example. The processing unit 12 is able to take into account, for example, the characteristic of each of the users U or the relationship between the users U in the group, and provide an answer or a proposal by reading between the lines.

The processing unit 12 serves as an acquisition unit and acquires, from the storage unit 11 or an external server, information on each of the users U, a conversation history in the chat group, or the like. The identification unit 41 of the processing unit 12 identifies the characteristic of each of the users U or the relationship between the users U in the group based on the information on each of the users U, the conversation history in the chat group, or the like.

Examples of the characteristic of the user U include the attribute of the user U and the behavior pattern of the user U. Examples of the attribute of the user U include a demographic attribute and a psychographic attribute. Examples of the behavior pattern of the user U include a purchase behavior pattern, a movement pattern, and a web search pattern, but embodiments are not limited to this example.

The relationship between the users U is, for example, a parent-child relationship, a colleague relationship, a boss-subordinate relationship, a friendship, a teacher-student relationship, or the like. The friendship includes a friendship in a Social Networking Service (SNS), a friendship based on same hobbies, a friendship in an online game, or the like, but embodiments are not limited to this example. Furthermore, the relationship between the users U includes a degree of intimacy, a reliability, dependency, a communication frequency, a degree of influence, a physical degree (a physical distance), or the like.

The identification unit 41 identifies the relationship between the users U in the group based on, for example, a conversation history that is a history of chat messages between the users U. Further, the identification unit 41 is able to identify the relationship between the users U in the group based on, for example, the attribute of each of the users U in the group or the like, in addition to or instead of the conversation history.

The identification unit 41 may input, as the input information, information that includes the history of chat messages between the users U and instruction information for instructing identification of the relationship between the users U based on the history to the generative AI, and may cause the generative AI to output an identification result of the relationship between the users U, for example.

In this case, the instruction information is, for example, information on a character string of “Please identify a relationship between users from a given history of chat messages between the users.” or the like, but embodiments are not limited to this example. The instruction information may include exemplary information on a combination of a relationship list, an exemplary message history, and an exemplary relationship, or the like.

Furthermore, the inquiry unit 43 makes an inquiry to one or more users U in the group about the predetermined information that is information on an unidentified parameter based on the characteristic of each of the users U or the relationship between the users U in the group that is identified by the identification unit 41.

For example, the inquiry unit 43 has, for each type of the service, certain information indicating an inquiry destination that is associated with at least one of the attribute of each of the users U and the relationship between the users U for each of unidentified parameters, and determines, as an inquiry destination user, the user U to whom an inquiry about the predetermined information is to be made based on the certain information, for example.

The inquiry unit 43 makes an inquiry to the determined inquiry destination user about the predetermined information. In this case, the determination processing unit 57 determines a value of an unidentified parameter based on the information that is provided by the inquiry destination user in accordance with the inquiry that is made by the inquiry unit 43.

Furthermore, the inquiry unit 43 may adjust a content of the inquiry message based on the characteristic of each of the users U or the relationship between the users U in the group that is identified by the identification unit 41. For example, the generation processing unit 53 of the inquiry unit 43 may further include, in the instruction information that is input to the generative AI, information for instructing consideration of the characteristic of the inquiry destination user or the relationship between the users U in the group.

For example, the generation processing unit 53 may adopt, as the instruction information that is to be input to the generative AI, information that includes information on a character string of “A character of each of the users in the group and a relationship between the users is as follows. Please create a sentence while taking into account the characters or the relationship.”, the characteristic of each of the users U in the group, and the relationship between the users U in the group.

Furthermore, the generation processing unit 53 may have, for each of the service types, information in which a plurality of pieces of instruction information are associated in accordance with the characteristic of each of the users U in the group or the relationship between the users U in the group, and may identify instruction information that corresponds to the unidentified parameter that is identified by the information identification unit 51.

Moreover, when a chat message of an inquiry that is made by the user U to the generative AI is present in a chat room of the group chat, the providing unit 44 may generate an answer to the inquiry made by the user U based on the characteristic of each of the users U in the group or the relationship between the users U in the group. The chat message that is made by the user U to the generative AI is, for example, information on a character string of “Hi AI, please tell me about XXX” (XXX is, for example, a proper noun or a specific phrase), or the like, but embodiments are not limited to this example.

The providing unit 44 is able to input, to the generative AI, information that includes a chat message that is made by the user U to the generative AI, information that indicates the characteristic of the user U of the chat message, and instruction information for instructing an answer to the chat message, and cause the generative AI to generate information that indicates the answer to the chat message, for example.

In this case, the instruction information is, for example, information on a character string of “Please create an answer to a given inquiry. At this time, please take into account a given characteristic of the user and create an answer that is suitable for the characteristic of the user.”, or the like, but embodiments are not limited to this example. Meanwhile, the instruction information may include exemplary information on a combination of an exemplary inquiry message, an exemplary characteristic of the user U, and an exemplary answer, or the like.

Furthermore, the providing unit 44 may provide information that corresponds to the relationship between the users U in the group to the user U. The providing unit 44 is able to input, to the generative AI, information that includes the chat message of the inquiry that is made by the user U to the generative AI, information that indicates the relationship between the users U in the group, and instruction information for instructing an answer to the chat message, and cause the generative AI to generate information that indicates the answer to the chat message, for example.

In this case, the instruction information is, for example, information on a character string of “Please create an answer to a given inquiry. At this time, please take into account a given relationship between the users U in the group and create a suitable answer.”, or the like, but embodiments are not limited to this example.

Meanwhile, the instruction information may include exemplary information on a combination of an exemplary chat message of an inquiry, an exemplary relationship between the users U in the group, and an exemplary answer, or the like.

Moreover, the providing unit 44 may provide information that corresponds to the characteristic of each of the users U in the group or the relationship between the users U in the group to the user U. The providing unit 44 is able to input, to the generative AI, information that includes the chat message of the inquiry that is made by the user U to the generative AI, information that indicates the characteristic of the user U of the chat message, information that indicates the relationship between the users U in the group, and instruction information for instructing an answer to the chat message, and cause the generative AI to generate information that indicates the answer to the chat message, for example.

In this case, the instruction information is, for example, information on a character string of “Please create an answer to a given inquiry. At this time, please take into account a given characteristic of the user and a given relationship between the users U in the group.”, or the like, but embodiments are not limited to this example. Meanwhile, the instruction information may include exemplary information on a combination of an exemplary chat message of an inquiry, an exemplary characteristic of the user U, and tan exemplary relationship between the users U in the group, and an exemplary answer, or the like.

Meanwhile, the providing unit 44 may provide an answer to a message that meets a predetermined condition, in addition to an answer to the chat message of an inquiry to the generative AI. The message that meets the predetermined condition is, for example, a chat message for which an inquiry destination is not clarified and for which other chat messages are not posted in the chat room within a predetermined period since post, but embodiments are not limited to this example.

### 6. Hardware Configuration

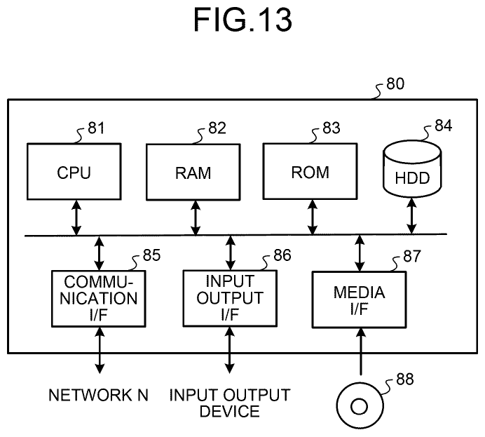

The information processing apparatus 1 according to one embodiment as described above is implemented by, for example, a computer 80 that has a configuration as illustrated in FIG. 13. FIG. 13 is a diagram illustrating an example of a hardware configuration of the computer 80 that implements the functions of the information processing apparatus 1 according to one embodiment. The computer 80 includes a CPU 81, a RAM 82, a Read Only Memory (ROM) 83, a Hard Disk Drive (HDD) 84, a communication interface (I/F) 85, an input output interface (I/F) 86, and a media interface (I/F) 87.

The CPU 81 operates based on a program that is stored in the ROM 83 or the HDD 84, and controls each of the units. The ROM 83 stores therein a boot program that is executed by the CPU 81 at the time of activation of the computer 80, a program that is dependent on hardware of the computer 80, and the like.

The HDD 84 stores therein a program that is executed by the CPU 81, data that is used by the program, and the like. The communication interface 85 receives data from a different apparatus via the network N (see FIG. 2), sends the data to the CPU 81, and transmits data that is generated by the CPU 81 to a different apparatus via the network N.

The CPU 81 controls an output device, such as a display and a printer, and an input device, such as a keyboard or a mouse, via the input output interface 86. The CPU 81 acquires data from the input device via the input output interface 86. Further, the CPU 81 outputs generated data to the output device via the input output interface 86.

The media interface 87 reads a program or data that is stored in a recording medium 88, and provides the program or the data to the CPU 81 via the RAM 82. The CPU 81 loads the program from the recording medium 88 onto the RAM 82 via the media interface 87, and executes the loaded program. The recording medium 88 is, for example, an optical recording medium, such as a Digital Versatile Disc (DVD) or a Phase change rewritable Disk (PD), a magneto-optical recording medium, such as a Magneto-Optical disk (MO), a tape medium, a magnetic recording medium, a semiconductor memory, or the like.

For example, when the computer 80 functions as the information processing apparatus 1 according to one embodiment, the CPU 81 of the computer 80 executes a program that is loaded on the RAM 82 and implements the functions of the processing unit 12. Further, the HDD 84 stores therein data in the storage unit 11. The CPU 81 of the computer 80 reads the programs from the recording medium 88 and executes the programs; however, as another example, it may be possible to acquire the programs from a different apparatus via the network N.

### 7. Others

Of the processes described in the embodiments above, all or part of a process described as being performed automatically may also be performed manually.

Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, the information processing apparatus 1 as described above may be implemented by a terminal apparatus and a server computer, may be implemented by a plurality of server computers, or may be implemented by calling an external platform or the like for some of the functions via an API, network computing, or the like, and the configuration may be flexibly changed.

Furthermore, the embodiments and the modifications as described above may be appropriately combined as long as processing contents do not conflict with each other.

### 8. Effects

As described above, the information processing apparatus 1 according to one embodiment includes the personal agent identification unit 50, the inquiry unit 43, and the providing unit 44. The personal agent identification unit 50 identifies the plurality of personal agents PA each being associated with a corresponding user among the plurality of users U who are grouped. The inquiry unit 43 makes an inquiry to one or more personal agents PA among the plurality of personal agents PA that are identified by the personal agent identification unit 50 about predetermined information that is used to provide a service to a group corresponding to the plurality of users U. The providing unit 44 provides the service to the group by using information that is provided by the one or more personal agents PA in accordance with an inquiry that is made by the inquiry unit 43. With this configuration, the information processing apparatus 1 is able to improve convenience of service provision to the plurality of users U who are grouped. With this configuration, the information processing apparatus 1 is able to improve convenience of service provision to the plurality of users U who are grouped.

Furthermore, the information processing apparatus 1 further includes the reception unit 40 that receives input information that includes information on a service from the user U, and the information identification unit 51 that identifies the predetermined information based on the input information that is received by the reception unit 40. With this configuration, the information processing apparatus 1 is able to improve convenience of service provision to the plurality of users U who are grouped.

Moreover, the information identification unit 51 further includes the first identification processing unit 60 that identifies a type of the service and values of one or more parameters among a plurality of parameters that are used to provide the service of the type based on the input information that is received by the reception unit 40, and the second identification processing unit 61 that identifies, as the predetermined information, information on an unidentified parameter that is a parameter for which a value is not yet identified among the plurality of parameters. With this configuration, the information processing apparatus 1 is able to improve convenience of service provision to the plurality of users U who are grouped.

Furthermore, the information processing apparatus 1 further includes the inquiry destination identification unit 52 that identifies the one or more personal agents PA based on the predetermined information that is identified by the information identification unit 51. With this configuration, the information processing apparatus 1 is able to improve convenience of service provision to the plurality of users U who are grouped.

Moreover, the providing unit 44 includes the determination processing unit 57 that determines the value of the unidentified parameter based on information that is provided by the one or more personal agents PA in accordance with an inquiry that is made by the inquiry unit 43, the acquisition processing unit 58 that acquires, from the service providing apparatus 3 that provides the service, service information that is information on the service based on values of the plurality of parameters that includes the value of the unidentified parameter that is determined by the determination processing unit 57 and based on the type of the service that is identified by the first identification processing unit 60, and the provision processing unit 59 that provides the service information that is acquired by the acquisition processing unit 58 to the group. With this configuration, the information processing apparatus 1 is able to improve convenience of service provision to the plurality of users U who are grouped.

Furthermore, the reception unit 40 receives setting to form a group of the plurality of users U for a group chat among the plurality of users U. With this configuration, the information processing apparatus 1 is able to improve convenience of service provision to the plurality of users U who are grouped for the group chat.

Moreover, the providing unit 44 includes the estimation processing unit 56 that estimates a situation of the group in a chat room by using generative AI based on a message history the plurality of users U in the chat room of the group chat, and the determination processing unit 57 that determines the value of the unidentified parameter based on an estimation result that is obtained by the estimation processing unit 56 when information corresponding to an inquiry that is made by the inquiry unit 43 is not provided from the one or more personal agents PA. With this configuration, the information processing apparatus 1 is able to improve convenience of service provision to the plurality of users U who are grouped.

Furthermore, the providing unit 44 includes the estimation processing unit 56 that estimates a characteristic of the group in a chat room by generative AI based on attribute information on the plurality of users U in the chat room of the group chat, and the determination processing unit 57 that determines the value of the unidentified parameter based on an estimation result that is obtained by the estimation processing unit 56 when information corresponding to an inquiry that is made by the inquiry unit 43 is not provided from the one or more personal agents PA. With this configuration, the information processing apparatus 1 is able to improve convenience of service provision to the plurality of users U who are grouped.

Moreover, the information processing apparatus 1 includes the estimation unit 42 that estimates a situation of the group in a chat room by using generative AI based on a message history of the plurality of users U in the chat room of the group chat, and the inquiry unit 43 provides information that indicates an estimation result obtained by the estimation unit 42 to the one or more personal agents when inquiring the predetermined information. With this configuration, the information processing apparatus 1 is able to improve convenience of service provision to the plurality of users U who are grouped.

Furthermore, the information processing apparatus 1 includes an estimation unit that estimates a characteristic of the group by using generative AI based on attribute information on the plurality of users in a chat room of the group chat, and the inquiry unit 43 provides information that indicates an estimation result obtained by the estimation unit 42 to the one or more personal agents PA when inquiring the predetermined information. With this configuration, the information processing apparatus 1 is able to improve convenience of service provision to the plurality of users U who are grouped.

Moreover, the inquiry unit 43 includes the generation processing unit 53 that generates inquiry information that indicates a sentence for inquiring the predetermined information by using generative AI, and the output processing unit 54 that outputs the inquiry information that is generated by the generation processing unit 53 to the one or more personal agents PA. With this configuration, the information processing apparatus 1 is able to appropriately make an inquiry to the personal agent PA.

Furthermore, each of the personal agents PA generates answer information that indicates an answer corresponding to the inquiry information by using the generative AI. With this configuration, the personal agent PA is able to give an appropriate answer.

Moreover, each of the personal agents PA makes an inquiry to the user U about whether the answer information is providable, and provides the answer information based on an answer from the user U. With this configuration, the personal agent PA is able to provide information from being provided before the user U realizes.

Thus, embodiments of the present application have been described in detail above based on the drawings, but the embodiments are described by way of example, and the present invention may be made in various different modes with various modifications and improvement based on knowledge of a person skilled in the art, in addition to the embodiments described in the section of the disclosure of the invention.

In addition, the “unit (section, module, unit)” described above may be replaced with a “means”, a “circuit”, or the like. For example, the acquisition unit may be replaced with an acquisition means or an acquisition circuit.

According to one aspect of embodiments, it is possible to improve convenience of service provision to a plurality of users who are grouped.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a personal agent identification unit that identifies a plurality of personal agents each being associated with a corresponding user among a plurality of users who are grouped;
an inquiry unit that makes an inquiry to one or more personal agents among the plurality of personal agents that are identified by the personal agent identification unit about predetermined information that is used to provide a service to a group corresponding to the plurality of users; and
a providing unit provides the service to the group by using information that is provided by the one or more personal agents in accordance with an inquiry that is made by the inquiry unit.

2. The information processing apparatus according to claim 1, further comprising:
a reception unit that receives input information that includes information on a service from the user; and
an information identification unit that identifies the predetermined information based on the input information that is received by the reception unit.

3. The information processing apparatus according to claim 2, wherein
the information identification unit includes
a first identification processing unit that identifies a type of the service and values of one or more parameters among a plurality of parameters that are used to provide the service of the type based on the input information that is received by the reception unit; and
a second identification processing unit that identifies, as the predetermined information, information on an unidentified parameter that is a parameter for which a value is not yet identified among the plurality of parameters.

4. The information processing apparatus according to claim 2, further comprising:
an inquiry destination identification unit that identifies the one or more personal agents based on the predetermined information that is identified by the information identification unit.

5. The information processing apparatus according to claim 3, wherein
the providing unit includes
a determination processing unit that determines a value of the unidentified parameter based on information that is provided by the one or more personal agents in accordance with an inquiry that is made by the inquiry unit;
an acquisition processing unit that acquires, from a service providing apparatus that provides the service, service information that is information on the service based on values of the plurality of parameters that includes the value of the unidentified parameter that is determined by the determination processing unit and based on the type of the service that is identified by the first identification processing unit; and
a provision processing unit that provides the service information that is acquired by the acquisition processing unit to the group.

6. The information processing apparatus according to claim 3, wherein the reception unit receives setting to form a group of the plurality of users for a group chat among the plurality of users.

7. The information processing apparatus according to claim 6, wherein
the providing unit includes
an estimation processing unit that estimates a situation of the group in a chat room by using generative AI based on a message history of the plurality of users in the chat room of the group chat; and
a determination processing unit that determines the value of the unidentified parameter based on an estimation result that is obtained by the estimation processing unit when information corresponding to an inquiry that is made by the inquiry unit is not provided from the one or more personal agents.

8. The information processing apparatus according to claim 6, wherein
the providing unit includes
an estimation processing unit that estimates a characteristic of the group in a chat room by using generative AI based on attribute information on the plurality of users in the chat room of the group chat; and
a determination processing unit that determines the value of the unidentified parameter based on an estimation result that is obtained by the estimation processing unit when information corresponding to an inquiry that is made by the inquiry unit is not provided from the one or more personal agents.

9. The information processing apparatus according to claim 6, further comprising:
an estimation unit that estimates a situation of the group in a chat room by using generative AI based on a message history of the plurality of users U in the chat room of the group chat, wherein
the inquiry unit provides information that indicates an estimation result obtained by the estimation unit to the one or more personal agents when inquiring the predetermined information.

10. The information processing apparatus according to claim 6, further comprising:
an estimation unit that estimates a characteristic of the group by using generative AI based on attribute information on the plurality of users in a chat room of the group chat, and
the inquiry unit provides information that indicates an estimation result obtained by the estimation unit to the one or more personal agents when inquiring the predetermined information.

11. The information processing apparatus according to claim 1, wherein
the inquiry unit includes
a generation processing unit that generates inquiry information that indicates a sentence for inquiring the predetermined information by using generative AI; and
an output processing unit that outputs the inquiry information that is generated by the generation processing unit to one or more personal agents.

12. The information processing apparatus according to claim 11, wherein each of the personal agents generates answer information that indicates an answer corresponding to the inquiry information by using generative AI.

13. The information processing apparatus according to claim 12, wherein each of the personal agents makes an inquiry to the user about whether the answer information is providable, and provides the answer information based on an answer from the user.

14. An information processing method that is implemented by a computer, the information processing method comprising:
identifying a plurality of personal agents each being associated with a corresponding user among a plurality of users who are grouped;
making an inquiry to one or more personal agents among the plurality of personal agents that are identified in the identifying about predetermined information that is used to provide a service to a group corresponding to the plurality of users; and
providing the service to the group by using information that is provided by the one or more personal agents in accordance with an inquiry that is made in the making the inquiry.

15. A non-transitory computer readable storage medium having stored therein an information processing program that causes a computer to execute a process, the process comprising:
identifying a plurality of personal agents each being associated with a corresponding user among a plurality of users who are grouped;
making an inquiry to one or more personal agents among the plurality of personal agents that are identified in the identifying about predetermined information that is used to provide a service to a group corresponding to the plurality of users; and
providing the service to the group by using information that is provided by the one or more personal agents in accordance with an inquiry that is made in the making the inquiry.
